(19) United States
(12) Patent Application Publication
(10) Pub. No.: US 2007/0214265 A1
(43) Pub. Date: Sep. 13, 2007

(54) Scalable captive portal redirect

(75) Inventors: Geoffrey Zampiello, Norwalk, CT (US); Jimmy Forsyth, Royal Oak, MI (US); Andy Prince, McKinney, TX (US); Taso Devetzis, Chicago, IL (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/370,811

(22) Filed: Mar. 7, 2006

(51) Int. Cl. G06F 15/173

(52) U.S. Cl. 709/226

(57) ABSTRACT

A system (100) and method (200) are disclosed for scalable captive portal and re-direct. A system that incorporates teachings of the present disclosure may include, for example, an authenticating server (114) having a controller (302) that manages operations of network application server (104) and a plurality of network routers (106). The controller can be programmed to receive a request for authenticating or authorizing a user (108, 110) via one of the plurality of network routers, authenticate or authorize the user when received authentication or authorization information matches stored information (120), and instruct the network application server to route traffic via one among the plurality of network routers to a captured portal at a webserver (112). The controller can be further programmed to capture (204) a portal during the authenticating or authorizing step and to load balance (208) traffic to the plurality of network routers. Additional embodiments are disclosed.

### FIELD OF THE DISCLOSURE

The present disclosure relates generally to communication networks, and more specifically to a captive portal redirecting scheme that is scalable.

### BACKGROUND

Captive portal re-direct systems (CPRD) have been utilized to redirect end users attempting to access a portal to a particular website or web page. This is especially useful in advertising applications. CPRD systems, however, lack scalability for large deployments. Current captive portal and re-direct systems require, for example, the use of a SESM (Subscriber Edge Services Manager) proprietary license. Under the current system, when a user logs into a network access server (NAS), their packets travel through a tunnel endpoint to a single service selection gateway (SSG). This arrangement ultimately causes two problems, namely that the tunnel can fail to handle the traffic and without scalability quickly becomes overloaded.

A need therefore arises for a captive portal and re-direct system that overcomes the aforementioned deficiencies.

### BRIEF DESCRIPTION OF THE DRAWINGS

FIG. 1 depicts an exemplary embodiment of a network architecture incorporating a scalable portal capture and re-direct scheme;

FIG. 2 depicts an exemplary method of scalable portal re-direct; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for a scalable portal and re-direct scheme.

In a first embodiment of the present disclosure, a method of scalable captive portal redirection can include the steps of receiving a request for a portal at a network server among a plurality of network servers, capturing the portal while being logged on to a network application server, redirecting the portal to a webserver through one of the plurality of network servers, and load balancing traffic to the plurality of network servers by using an authenticating server. Load balancing traffic can be achieved by applying a round robin scheme to host names for a tunnel endpoint among the plurality of network servers. Load balancing can further involve having the authenticating server use a domain name server to serve records in a round robin fashion back to a script residing on the authenticating server. The method can further serve the network application server with one of several tunnel endpoint identifiers corresponding to the tunnel endpoint among the plurality of network servers assigned. The method can also further include the steps of distributing and scaling a load to a network server based on an application of attributes at the authenticating server of a particular user profile at the time of authentication and authorization for a particular user corresponding to the particular user profile.

In a second embodiment of the present disclosure, an authenticating server can include a controller that manages operations of network application server and a plurality of network routers. The controller can be programmed to receive a request for authenticating or authorizing a user for a website via one of the plurality of network routers, authenticate or authorize the user for the website when received authentication or authorization information matches stored information, and instruct a network application server to route traffic via one among the plurality of network routers to a captured portal at a webserver. The controller can be further programmed to capture a portal during the authenticating or authorizing step and to load balance traffic to the plurality of network routers. As discussed above, balancing traffic can be done by applying a round robin scheme to host names for a tunnel endpoint among the plurality of network routers and/or by having the authenticating server use a domain name server to serve records in a round robin fashion back to a script residing on the authenticating server. Also note that the controller can be programmed to instruct the network application server to route traffic via another network application server and further use one among the plurality of network routers to route traffic to a captured portal at a webserver.

The controller can be further programmed to serve the network application server with one of several tunnel endpoint identifiers corresponding to the tunnel endpoint among the plurality of routers assigned. The controller can be further programmed to distribute and scale a load to a network server based on an application of attributes at the authenticating server of a particular user profile at the time of authentication and authorization for a particular user corresponding to the particular user profile. Note, the network server can operate as a Layer-2 Tunnel Protocol (L2TP) access concentrator (LAC) and the plurality of routers can operate as a plurality of L2TP network servers (LNSs).

In a third embodiment of the present disclosure, a router in a communication system having a plurality of routers can include a controller in the router programmed to receive instructions via a network application server from an authentication server, dynamically redirect traffic in accordance with instructions from the authentication server to a webserver after the authentication server authenticates or authorizes the user for the website when received authentication or authorization information matches stored information, and route traffic to a captured portal at the webserver until the authentication server instructs the router to redirect the traffic elsewhere. The controller can be further programmed to switch as instructed by the authentication servers to load balance traffic to the plurality of routers.

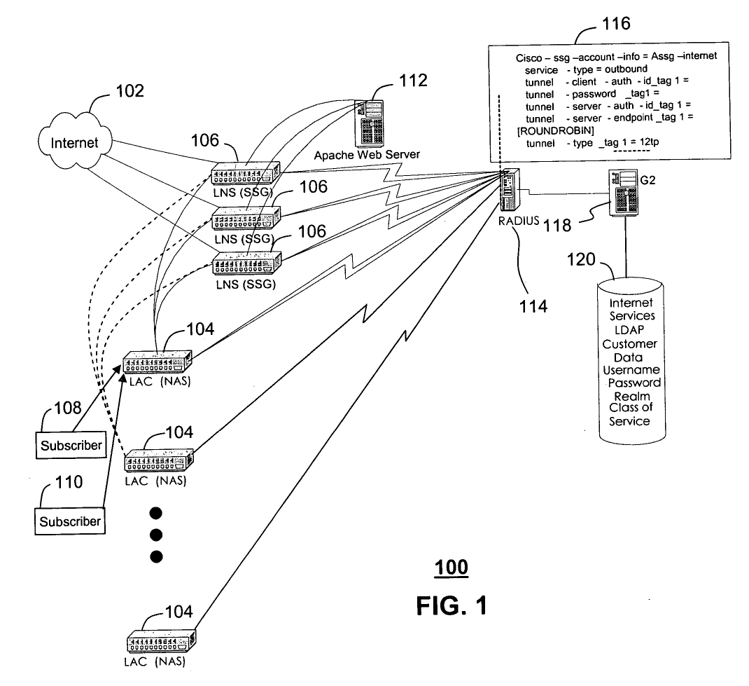

Existing captive portal redirection systems lack fundamental scaling requirements for large scale deployments using (Subscriber Edge Services Manager) SESM, but embodiments herein can scale without the use of an SESM. By removing the SESM configurations from the SSG and inputting an IP address of a web server (for example, running Apache server software), the web server can serve the re-direct portal to a customer. Referring to FIG. 1, a network architecture 100 is illustrated that enables a scalable portal capture and re-direct system. The architecture 100 can include a plurality of network access servers (NAS) 104 in communication with routers or Layer 2 Tunneling Protocol (L2TP) Network Servers (LNS) 106 that can serve as the selection service gateway (SSG). The servers 104 and routers or LNSs 106 are also in communication with a webserver 112 and an authentication server 114 as will be further discussed. The authentication sever 114 can be a remote authentication dial-in user service (RADIUS) server.

In accordance with the embodiments herein, the authentication server 114 can include profiles that allow for load balancing of the routers or SSGs. Instead of a user or subscriber 108 or 110 logging into the NAS 104 where their packets would travel through a tunnel endpoint to a single SSG 106 that can become quickly overloaded, the authentication server 114 can use a script (such as a RADIUS script) our routing instruction 116 that has the ability to apply round robin host names for the tunnel endpoint. The RADIUS script can look to a domain name server (DNS) and the DNS can serve records in a round robin fashion back to the script, which would then serve the NAS 104 one of several tunnel endpoint ID's corresponding to one of the SSGs 106. The result is the ability to distribute and scale the load to an SSG 106 based on the application of RADIUS attributes to the user profile at the time of Authentication and Authorization. Note, the authentication server 114 can utilize or access a database 120 containing for example LDAP (Lightweight Directory Access Protocol) customer data via a Hewlett Packard G2 server 118 in the application of user profiles as described above.

In one particular embodiment, a port 80 captive portal redirect can use a Cisco 7200 router running SSG software. The SSG was originally designed to be used with a Cisco SESM (Subscriber Edge Service Manager), but it was discovered that initial captive and re-direct activities can take place without the use of the SESM. Specifically, portal capture and re-direct can take place by directing the captive user to an IP address of any web server that is configured in such a way that it would answer all HTTP requests without a specific host. In conjunction with an authentication server such as a RADIUS server, the architecture can load balance and scale any deployment of SSG's. Upon RADIUS authentication of a user, the developed functionality uses a host name with several records in order to load balance.

In other words with respect to load balancing, an LNS 106 can receive instructions from an authentication server 114 for load balancing and forward such instructions to the plurality of network access servers 104. If a particular NAS 104 approaches an overloaded condition, the server can re-direct further traffic through other NAS 104 in the architecture as instructed by the authentication server 114. This arrangement compensates for wide scale deployment since it is not limited to the existing static configuration of pushing user traffic between a mated LAC (104) and LNS (106). The discovery of configuring a router or SSG 106 to re-direct to a webserver (112) that answers from a root directory greatly improves the cost and scalability of this particular arrangement or architecture. Furthermore, the use a RADIUS script 116 that can utilize a DNS server to insert host names for the purpose of load balancing can significantly improve the scalability and feasibility of a wide scale deployment of this solution.

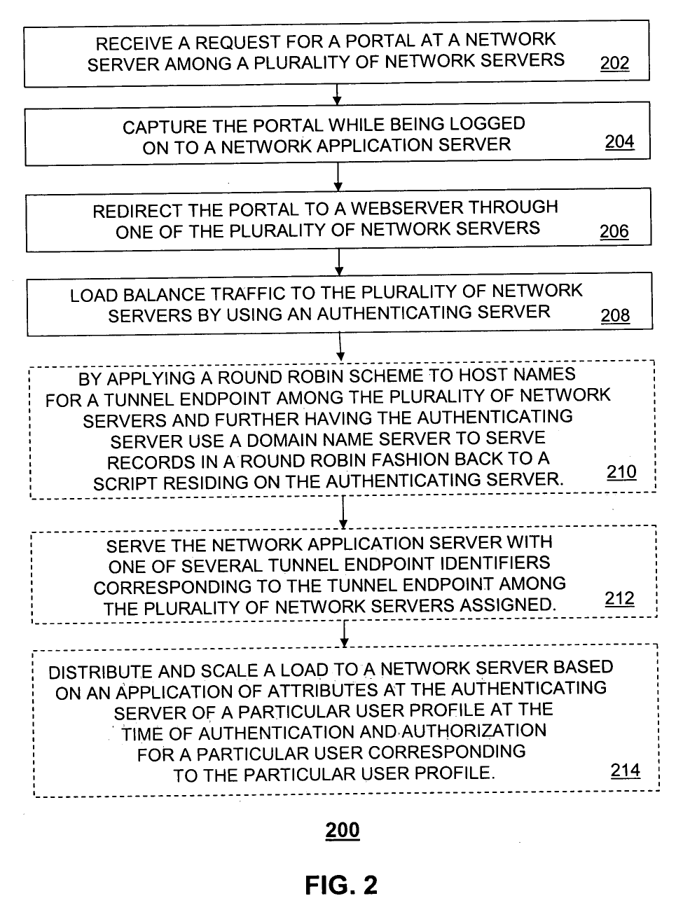

Referring to FIG. 2, a method 200 of scalable captive portal redirect can include the step 202 of receiving a request for a portal at a network server among a plurality of network servers, capturing the portal while being logged on to a network application server at step 204, redirecting the portal to a webserver through one of the plurality of network servers at step 206, and load balancing traffic to the plurality of network servers by using an authenticating server at step 208. Optionally, load balancing of traffic can be achieved at step 210 by applying a round robin scheme to host names for a tunnel endpoint among the plurality of network servers. Load balancing can further involve having the authenticating server use a domain name server to serve records in a round robin fashion back to a script residing on the authenticating server. The method 200 can further serve the network application server with one of several tunnel endpoint identifiers corresponding to the tunnel endpoint among the plurality of network servers assigned at step 212. The method can also further include the step 214 of distributing and scaling a load to a network server based on an application of attributes at the authenticating server of a particular user profile at the time of authentication and authorization for a particular user corresponding to the particular user profile.

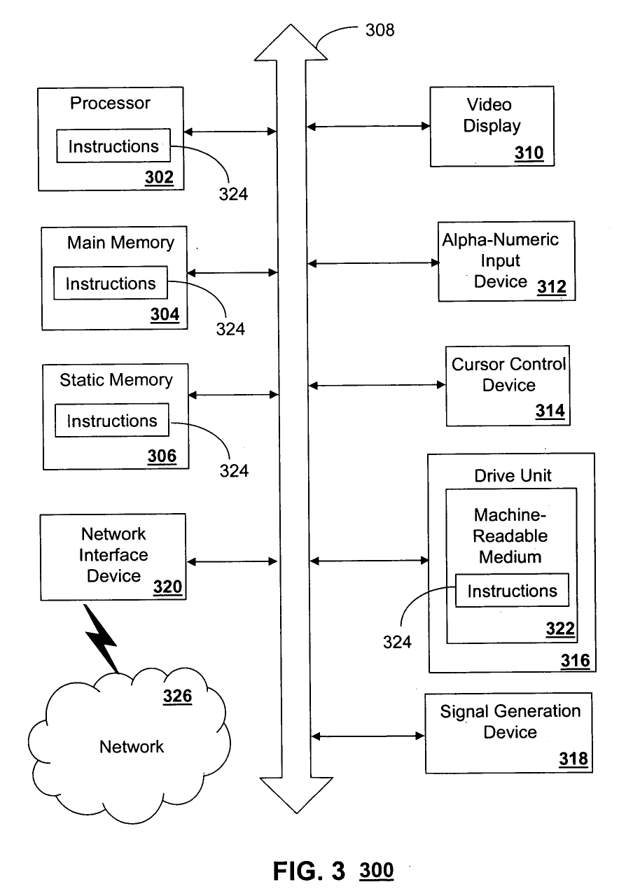

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320. Of course, in the embodiments disclosed, many of these items are optional.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of scalable captive portal redirection, comprising the steps of:
receiving a request for a portal at a network server among a plurality of network servers;
capturing the portal while being logged on to a network application server;
redirecting the portal to a webserver through one of the plurality of network servers; and
load balancing traffic to the plurality of network servers by using an authenticating server.

2. The method of claim 1, comprising applying a round robin scheme to host names for a tunnel endpoint among the plurality of network servers.

3. The method of claim 2, wherein the step of load balancing further comprises the step of having the authenticating server use a domain name server to serve records in a round robin fashion to a script residing on the authenticating server.

4. The method of claim 3, comprising the step of serving the network application server with one of several tunnel endpoint identifiers corresponding to the tunnel endpoint among the plurality of network servers assigned.

5. The method of claim 1, wherein the method further comprises the step of distributing and scaling a load to a network server based on an application of attributes at the authenticating server of a particular user profile at the time of authentication and authorization for a particular user corresponding to the particular user profile.

6. An authenticating server, comprising:
a controller that manages operations of network application servers and a plurality of network routers, wherein the controller is programmed to:
receive a request for authenticating or authorizing a user for a website via one of the plurality of network routers;
authenticate or authorize the user for the website when the received authentication or authorization information matches stored information; and
instruct a network application server to route traffic via one among the plurality of network routers to a captured portal at a webserver.

7. The authenticating server of claim 6, wherein the controller is further programmed to capture a portal during the authenticating or authorizing step.

8. The authenticating server of claim 6, wherein the controller is further programmed to load balance traffic to the plurality of network routers.

9. The authenticating server of claim 8, wherein the controller is further programmed to balance traffic by applying a round robin scheme to host names for a tunnel endpoint among the plurality of network routers.

10. The authenticating server of claim 8, wherein the controller is further programmed to load balance traffic by having the authenticating server use a domain name server to serve records in a round robin fashion back to a script residing on the authenticating server.

11. The authenticating server of claim 9, wherein the controller is further programmed to serve the network application server with one of several tunnel endpoint identifiers corresponding to the tunnel endpoint among the plurality of routers assigned.

12. The authenticating server of claim 9, wherein the controller is further programmed to distribute and scale a load to a network server based on an application of attributes at the authenticating server of a particular user profile at the time of authentication and authorization for a particular user corresponding to the particular user profile.

13. The authenticating server of claim 6, wherein the network server operates as a Layer-2 Tunnel Protocol (L2TP) access concentrator (LAC) and the plurality of routers operate as a plurality of L2TP network servers (LNSs).

14. The authenticating server of claim 6, wherein the controller is further programmed to instruct the network application server to route traffic via another network application server and further use one among the plurality of network routers to route traffic to a captured portal at a webserver.

15. A router in a communication system having a plurality of routers, comprising:
a controller in the router programmed to:
receive instructions via a network application server from an authentication server:
dynamically redirect traffic in accordance with instructions from the authentication server to a webserver after the authentication server authenticates or authorizes the user for the website when received authentication or authorization information matches stored information; and
route traffic to a captured portal at the webserver until the authentication server instructs the router to redirect the traffic elsewhere.

16. The router of claim 15, wherein the controller is further programmed to switch as instructed by the authentication servers to load balance traffic to the plurality of routers.

17. A computer-readable storage medium operating in an authenticating server, comprising computer instructions for:
receiving a request for a portal at a network router among a plurality of network routers;
redirecting the portal to a webserver through one of the plurality of network routers; and
directing traffic among the plurality of network routers via a network application server using a script residing at the authenticating server.

18. The computer readable storage medium of claim 17, wherein the medium further comprises computer instructions for load balancing traffic among the plurality of network routers by applying a round robin scheme to host names for a tunnel endpoint among the plurality of network routers.

19. The computer readable storage medium of claim 18, wherein the medium further comprises computer instructions for load balancing by having the authenticating server use a domain name server to serve records in a round robin fashion back to a script residing on the authenticating server.

20. The computer readable storage medium of claim 19, wherein the medium further comprises computer instructions for serving the network application server with one of several tunnel endpoint identifiers corresponding to the tunnel endpoint among the plurality of network routers assigned.

21. The computer readable storage medium of claim 17, wherein the medium further comprises computer instructions for distributing and scaling a load to a network router based on an application of attributes at the authenticating server of a particular user profile at the time of authentication and authorization for a particular user corresponding to the particular user profile.
